(19) United States
(12) Patent Application Publication
(10) Pub. No.: US 2026/0138503 A1
(43) Pub. Date: May 21, 2026

(54) VEHICLE SEAT AND VEHICLE SEAT CONTROL METHOD

(71) Applicant: TOYOTA JIDOSHA KABUSHIKI KAISHA, Toyota-shi (JP)

(72) Inventor: Yoshiki TAKAHIRA, Nagoya-shi (JP)

(73) Assignee: TOYOTA JIDOSHA KABUSHIKI KAISHA, Toyota-shi (JP)

(21) Appl. No.: 19/333,651

(22) Filed: Sep. 19, 2025

(30) Foreign Application Priority Data
Nov. 21, 2024 (JP) 2024-203334

(51) Int. Cl. B60N 2/02; B60N 2/22; B60N 2/66; B60R 21/0134; B60R 21/207

(52) U.S. Cl. CPC B60N 2/0276; B60N 2/22; B60N 2/665; B60N 2/02246; B60R 21/0134; B60R 21/207

(57) ABSTRACT

A vehicle seat and a control method for the vehicle seat include a seat cushion on which an occupant is seated, a seat back that is configured to be reclinable and to support a back of the occupant, a lifting mechanism provided in the seat cushion and configured to lift a front portion of a seat surface of the seat cushion, and a pressing mechanism provided in the seat back and configured to press a portion of a front surface of the seat back toward a front side of a seat. When a reclining angle of the seat back is equal to or greater than a predetermined angle and a frontal collision of a vehicle is predicted, the pressing mechanism is operated after the lifting mechanism is operated.

### CROSS-REFERENCE TO RELATED APPLICATION

This application claims priority to Japanese Patent Application No. 2024-203334 filed on Nov. 21, 2024. The disclosure of the above-identified application, including the specification, drawings, and claims, is incorporated by reference herein in its entirety.

### BACKGROUND

### 1. Technical Field

The present disclosure relates to a vehicle seat and a vehicle seat control method.

### 2. Description of Related Art

A vehicle occupant protection device is known that deploys an airbag between the seat back and the occupant's upper body to raise the occupant's upper body when it is determined that a frontal collision of a vehicle is inevitable and the inclination angle of the seat back is equal to or greater than a predetermined angle (for example, see Japanese Unexamined Patent Application Publication No. 2020-069871 (JP 2020-069871 A)). Further, a vehicle seat structure is also known in which, when a seated occupant moves forward during a collision, an upper portion of the lumbar of the occupant is pressed toward a front side of the seat by a pyrotechnic lumbar support, thereby tilting the occupant's pelvis forward (for example, see Japanese Unexamined Patent Application Publication No. 2020-055500 (JP 2020-055500 A)).

### SUMMARY

With the widespread adoption of autonomous driving, traveling in a reclined posture (comfortable posture) in which the seat back is significantly reclined is assumed. However, in such a reclined posture, due to the inertial force during the frontal collision of the vehicle, the axial component along the spine of the occupant's upper body increases, and therefore a lumbar spine load may increase. In addition, when the seated occupant's back is pressed toward a front side by an airbag or a lumbar support to suppress an increase in the lumbar spine load, the seated occupant may move toward the front side, and thus the effect of suppressing the occurrence of a submarining phenomenon may not be sufficient.

Therefore, an object of the present disclosure is to obtain a vehicle seat and a vehicle seat control method capable of suppressing the occurrence of a submarining phenomenon to an occupant even when a vehicle experiences a frontal collision while traveling with the seat back reclined by an angle equal to or greater than a predetermined angle.

A vehicle seat according to an aspect of the present disclosure includes:
a seat cushion on which an occupant is seated;
a seat back configured to be reclinable and to support a back of the occupant;
a lifting mechanism provided in the seat cushion and configured to lift a front portion of a seat surface of the seat cushion; and
a pressing mechanism provided in the seat back and configured to press part of a front surface of the seat back toward a front side of the vehicle seat.
   When a reclining angle of the seat back is equal to or greater than a predetermined angle and a frontal collision of a vehicle is predicted, the pressing mechanism is operated after the lifting mechanism is operated.

According to the aspect, a seat cushion on which an occupant is seated is provided with a lifting mechanism configured to lift a front portion of a seat surface of the seat cushion. Further, a pressing mechanism configured to press part of a front surface of a seat back that is configured to be reclinable and to support a back of the occupant toward a front side of the vehicle seat is provided in the seat back.

Here, when a reclining angle of the seat back is equal to or greater than a predetermined angle and a frontal collision of a vehicle is predicted, the pressing mechanism is operated after the lifting mechanism is operated. That is, after the front portion of the seat surface of the seat cushion is lifted, part of the front surface of the seat back is pressed toward the front side of the vehicle seat. Therefore, the movement of the occupant toward the front side is effectively suppressed. Therefore, even when the vehicle experiences a frontal collision while traveling with the seat back reclined by an angle equal to or greater than a predetermined angle, the occurrence of the submarining phenomenon to the occupant is suppressed.

In the vehicle seat according to the aspect,
the lifting mechanism may be an electric tilt mechanism, a cushion restraint device, or a seat cushion airbag, and
the pressing mechanism may be a lumbar support airbag or an electric lumbar support.

With the above configuration, the lifting mechanism is an electric tilt mechanism, a cushion restraint device, or a seat cushion airbag. Therefore, the front portion of the seat surface of the seat cushion is effectively lifted. The pressing mechanism is a lumbar support airbag or an electric lumbar support. Therefore, part of the front surface of the seat back is effectively pressed toward the front side of the vehicle seat.

A vehicle seat control method of controlling the vehicle seat according to the aspect may include:
operating the lifting mechanism to lift the front portion of the seat surface of the seat cushion when the reclining angle of the seat back is equal to or greater than the predetermined angle and the frontal collision of the vehicle is predicted; and
after the front portion of the seat surface of the seat cushion is lifted, operating the pressing mechanism to press the part of the front surface of the seat back toward the front side of the vehicle seat.

According to the aspect, the front portion of the seat surface of the seat cushion is lifted when the reclining angle of the seat back is equal to or greater than the predetermined angle and the frontal collision of the vehicle is predicted (lifting). Then, the part of the front surface of the seat back is pressed toward the front side of the vehicle seat (pressing). Therefore, the movement of the occupant toward the front side is effectively suppressed. Therefore, even when the vehicle experiences a frontal collision while traveling with the seat back reclined by an angle equal to or greater than a predetermined angle, the occurrence of the submarining phenomenon to the occupant is suppressed.

As described above, according to the present disclosure, it is possible to suppress the occurrence of a submarining phenomenon to an occupant even when a vehicle experiences a frontal collision while traveling with a seat back reclined by an angle equal to or greater than a predetermined angle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view showing a configuration of a vehicle seat according to a first embodiment;

FIG. 2A is a schematic side view showing a state in which a lifting mechanism of the vehicle seat according to the first embodiment is operated;

FIG. 2B is a schematic side view showing a state in which a pressing mechanism of the vehicle seat according to the first embodiment is operated;

FIG. 3 is a flowchart showing an operation of the vehicle seat according to the first embodiment;

FIG. 4A is a schematic side view showing a state in which a lifting mechanism of a vehicle seat according to a second embodiment is operated;

FIG. 4B is a schematic side view showing a state in which a pressing mechanism of a vehicle seat according to the second embodiment is operated;

FIG. 5 is a flowchart showing an operation of the vehicle seat according to the second embodiment;

FIG. 6A is a schematic side view showing a state in which a lifting mechanism of a vehicle seat according to a third embodiment is operated;

FIG. 6B is a schematic side view showing a state in which a pressing mechanism of the vehicle seat according to the third embodiment is operated; and

FIG. 7 is a flowchart showing an operation of the vehicle seat according to the third embodiment.

### DETAILED DESCRIPTION OF EMBODIMENTS

Hereinafter, embodiments according to the present disclosure will be described in detail with reference to the drawings. For convenience of description, in each of the drawings, an arrow UP is a seat upward direction, and an arrow FR is a seat front direction. In addition, in the following description, unless otherwise specified, the upper and lower, front and rear, and right and left directions refer to the upper and lower, front and rear, and right and left of the seat. In addition, the left and right direction is the same as the seat width direction.

### First Embodiment

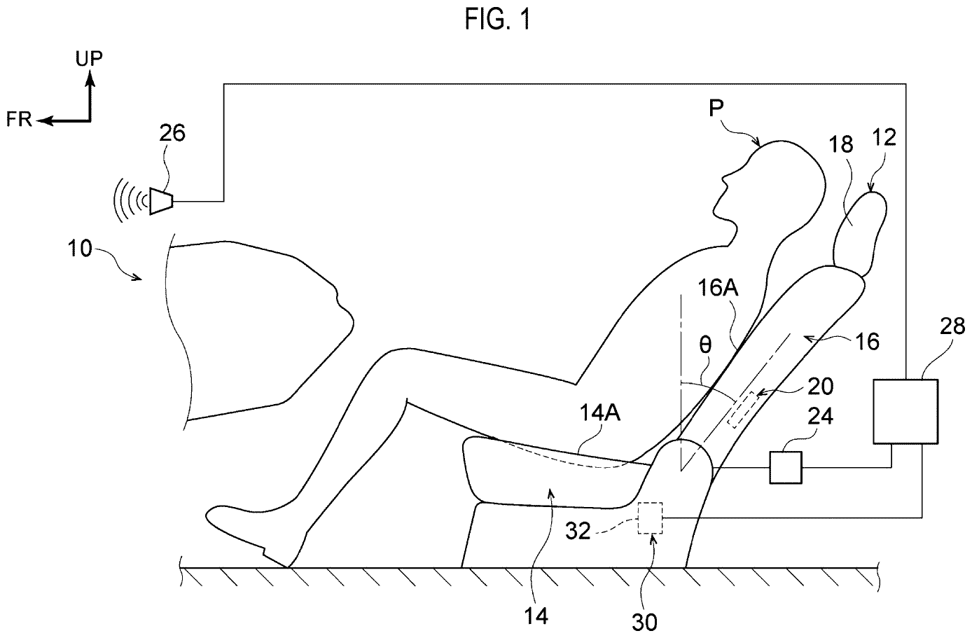

First, a first embodiment will be described. As shown in FIG. 1, the vehicle seat 12 according to the first embodiment is provided as, for example, a front seat of the vehicle 10 having the autonomous driving mode. The vehicle seat 12 includes a seat cushion 14 on which an occupant is seated and is provided at a rear side of the seat cushion 14 to be pivotable (reclinable and tiltable forward) about an axial direction that is a seat width direction. The vehicle seat 12 includes a seat back 16 that supports the back of the occupant and a headrest 18 that is provided to be movable up and down at a central portion of the seat width direction at an upper end portion of the seat back 16 and supports the head of the occupant.

In FIG. 1 and the like, a collision test dummy (human body dummy) is shown seated on the seat cushion 14 of the vehicle seat 12 as a model of an occupant (seated person) to be protected. The dummy is, for example, an AM50 (50th percentile of US adult male) dummy (Hybrid III) for frontal collision tests. The dummy is hereinafter referred to as an “occupant P”.

As shown in FIG. 1, when the vehicle 10 is in the autonomous driving mode, the occupant P may take a reclining posture in which the seat back 16 is reclined by a predetermined angle θ or more with respect to the vertical direction. In FIG. 1, as an example, a state in which the seat back 16 is reclined at 45 degrees with respect to the vertical direction is shown, and the predetermined angle θ is, for example, 45 degrees.

The reclining angle of the seat back 16 is detected by a detection sensor 24 or the like. In addition, the vehicle 10 is provided with a prediction sensor 26 or the like that predicts the frontal collision at a predetermined position. In addition, the vehicle 10 is provided with a control device 28 electrically connected to the detection sensor 24 and the prediction sensor 26 at a predetermined position.

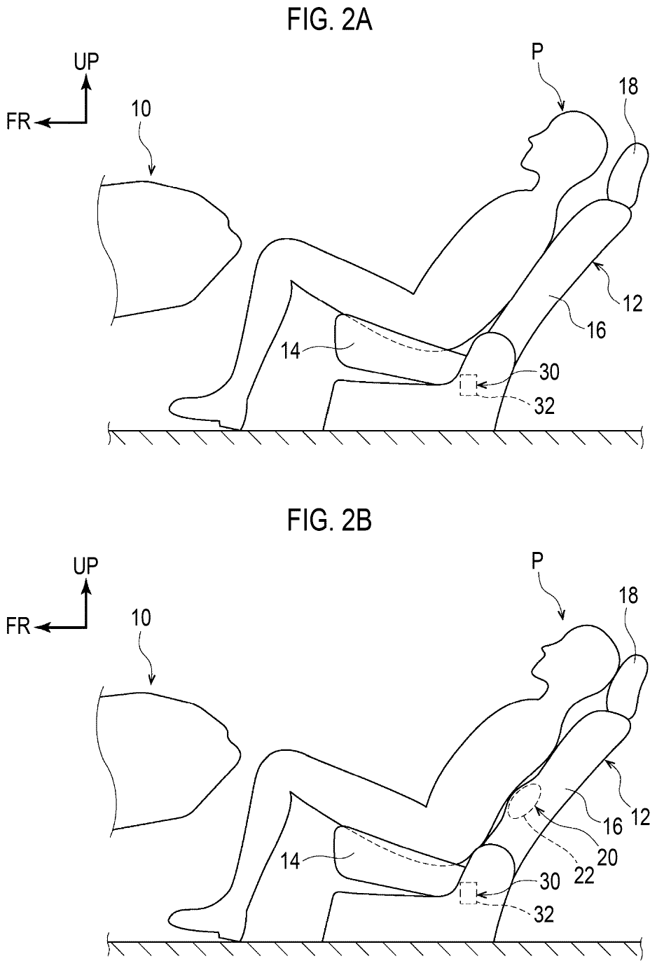

As shown in FIG. 2B, the seat back 16 is provided with a lumbar support airbag 22 that presses a portion of the front surface 16A of the seat back 16 forward, and an inflator (not shown) that injects gas into the lumbar support airbag 22. A portion of a front surface 16A of the seat back 16 is specifically a skin of a portion facing the lumbar of the occupant P. The pressing mechanism 20 is configured with the lumbar support airbag 22 and the inflator that injects gas into the lumbar support airbag 22, and the inflator is also electrically connected to the control device 28 (see FIG. 1).

The pressing mechanism 20 is not limited to the one including the lumbar support airbag 22 and the inflator that injects the gas into the lumbar support airbag 22. Although not shown, for example, the electric lumbar support may be an electric lumbar support configured to include, for example, a plate or the like that is moved forward by driving the electric motor to press a portion of the front surface 16A of the seat back 16 forward. In this case, the electric motor is electrically connected to the control device 28.

As shown in FIGS. 2A and 2B, the seat cushion 14 is provided with an electric tilt mechanism 32 as a lifting mechanism 30 that lifts the front portion of the seat surface 14A of the seat cushion 14. The electric tilt mechanism 32 is a known mechanism and is electrically connected to the control device 28.

The control device 28 is configured to first operate the electric tilt mechanism 32 when the reclining angle of the seat back 16 is equal to or greater than a predetermined angle θ and the frontal collision of the vehicle 10 is predicted. Thereafter (with a predetermined time difference), the control device 28 is configured to operate the inflator that injects the gas into the lumbar support airbag 22, thereby inflating the lumbar support airbag 22.

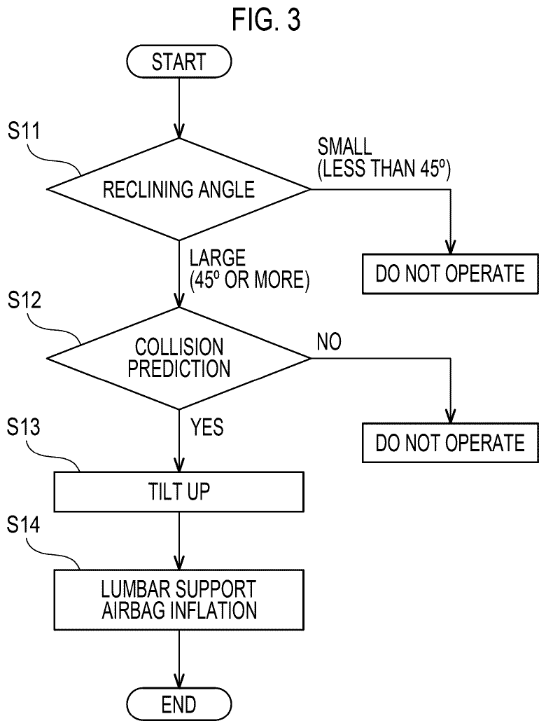

In the vehicle seat 12 according to the first embodiment configured as described above, the operation (control method) will be described below with reference to a flowchart shown in FIG. 3.

As shown in FIG. 3, first, the reclining angle of the seat back 16 is detected by the detection sensor 24 (S11). When the reclining angle is less than a predetermined angle θ (for example, θ=45 degrees), the lifting mechanism 30 and the pressing mechanism 20 do not operate. When the reclining angle is equal to or greater than a predetermined angle θ, it is then determined whether a frontal collision prediction of the vehicle 10 is predicted (S12). In a case where a frontal collision of the vehicle 10 is not predicted, the lifting mechanism 30 and the pressing mechanism 20 do not operate.

In a case where a frontal collision of the vehicle 10 is predicted, first, as shown in FIG. 2A, the control device 28 operates the electric tilt mechanism 32 as the lifting mechanism 30 to lift the front portion of the seat cushion 14 (lifting step: S13). Thereafter, as shown in FIG. 2B, the control device 28 operates the pressing mechanism 20. That is, the control device 28 operates the inflator that injects gas into the lumbar support airbag 22, thereby inflating the lumbar support airbag 22 (pressing step: S14).

As described above, when the reclining angle of the seat back 16 is equal to or greater than the predetermined angle θ and the frontal collision of the vehicle 10 is predicted, the pressing mechanism 20 is operated after the lifting mechanism 30 is operated. That is, after the front portion of the seat surface 14A of the seat cushion 14 is lifted, a portion of the front surface 16A of the seat back 16 is pressed toward the front side. Therefore, the movement of the occupant P toward the front side is effectively suppressed. Therefore, even when the vehicle 10 experiences a frontal collision while traveling with the seat back 16 reclined by a predetermined angle θ or more, the occurrence of the submarining phenomenon in the occupant P can be effectively suppressed.

In addition, since the lifting mechanism 30 is the electric tilt mechanism 32, the front portion of the seat surface 14A of the seat cushion 14 can be effectively lifted. In addition, since the pressing mechanism 20 is the lumbar support airbag 22, a portion of the front surface 16A of the seat back 16 can be effectively pressed toward the front side. The same applies in a case where the pressing mechanism 20 is an electric lumbar support.

### Second Embodiment

Next, a second embodiment will be described. The same reference numerals are given to the same parts as those in the first embodiment, and detailed descriptions will be omitted as appropriate.

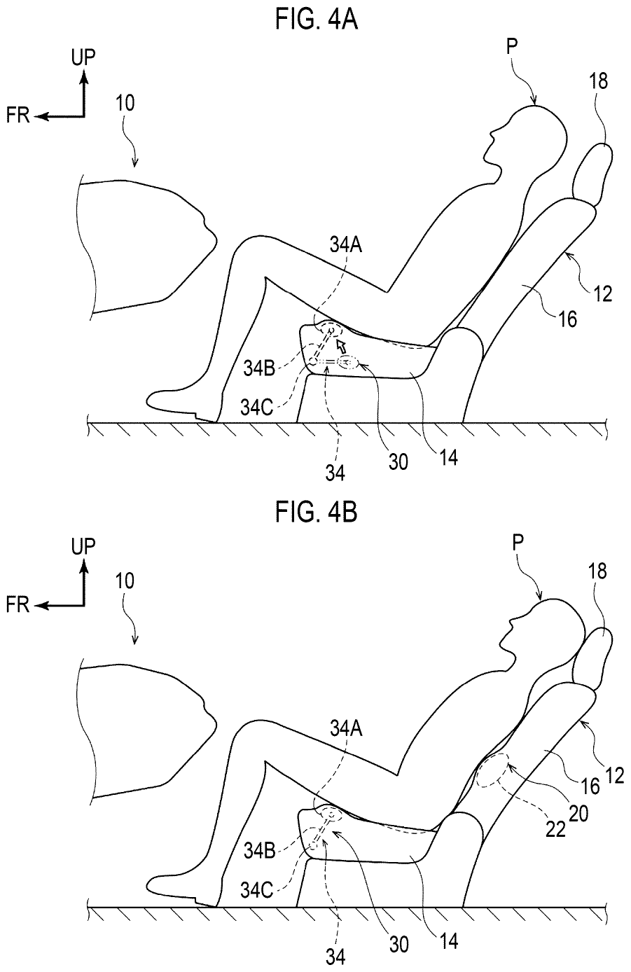

As shown in FIGS. 4A and 4B, the second embodiment differs from the first embodiment merely in that the lifting mechanism 30 is configured with a cushion restraint device (hereinafter referred to as “CRD 34”). The CRD 34 is built in the front portion of the seat cushion 14.

The CRD 34 includes a main body portion 34A extending in the seat width direction, a support rod 34B, and a pivot shaft 34C. The support rod 34B is provided with one end portion pivotable at both end portions of the main body portion 34A in the seat width direction. The pivot shaft 34C is provided in the seat width direction as the axial direction.

The main body portion 34A is made of, for example, resin, and is provided in a substantially elliptical shape having a predetermined thickness in a side view. The pivot shaft 34C is rotatably supported at a front end portion of a seat cushion frame (not shown) provided inside the seat cushion 14. An electric motor (not shown) is connected to the pivot shaft 34C via a gearbox (not shown), and the electric motor is electrically connected to the control device 28.

Therefore, the control device 28 first operates the electric motor when the reclining angle of the seat back 16 is equal to or greater than the predetermined angle θ and the frontal collision of the vehicle 10 is predicted. That is, the control device 28 drives the electric motor to rotate the pivot shaft 34C in the counterclockwise direction shown in the drawing, thereby lifting the main body portion 34A of the CRD 34. Thereafter, the control device 28 operates the inflator that injects gas into the lumbar support airbag 22, thereby inflating the lumbar support airbag 22.

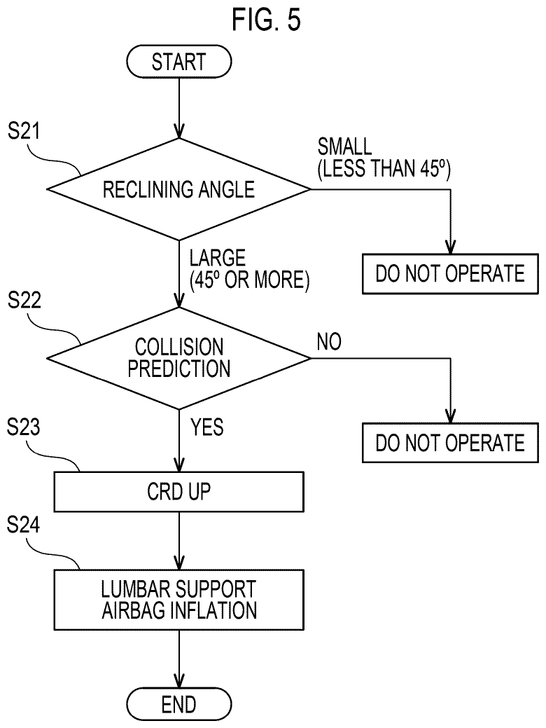

In the vehicle seat 12 according to the second embodiment configured as described above, the operation (control method) will be described below with reference to a flowchart shown in FIG. 5. The same operations as those of the first embodiment will be omitted as appropriate.

As shown in FIG. 5, first, the reclining angle of the seat back 16 is detected by the detection sensor 24 (S21). When the reclining angle is less than a predetermined angle θ (for example, θ=45 degrees), the lifting mechanism 30 and the pressing mechanism 20 do not operate. When the reclining angle is equal to or greater than a predetermined angle θ, it is then determined whether a frontal collision prediction of the vehicle 10 is predicted (S22). In a case where a frontal collision of the vehicle 10 is not predicted, the lifting mechanism 30 and the pressing mechanism 20 do not operate.

In a case where a frontal collision of the vehicle 10 is predicted, first, as shown in FIG. 4A, the control device 28 operates the CRD 34 as the lifting mechanism 30 to lift the front portion of the seat cushion 14 (lifting step: S23). Thereafter, as shown in FIG. 4B, the control device 28 operates the pressing mechanism 20. That is, the control device 28 operates the inflator that injects gas into the lumbar support airbag 22, thereby inflating the lumbar support airbag 22 (pressing step: S24).

As described above, in the second embodiment, as in the first embodiment, when the reclining angle of the seat back 16 is equal to or greater than the predetermined angle θ and the frontal collision of the vehicle 10 is predicted, the pressing mechanism 20 is operated after the lifting mechanism 30 is operated. That is, after the front portion of the seat surface 14A of the seat cushion 14 is lifted, a portion of the front surface 16A of the seat back 16 is pressed toward the front side.

Therefore, the movement of the occupant P toward the front side is effectively suppressed, and even when the vehicle 10 experiences a frontal collision while traveling with the seat back 16 reclined by a predetermined angle θ or more, the occurrence of the submarining phenomenon in the occupant P can be effectively suppressed. In addition, since the lifting mechanism 30 is the CRD 34, the front portion of the seat surface 14A of the seat cushion 14 can be effectively lifted.

### Third Embodiment

Finally, a third embodiment will be described. The same reference numerals are given to the same parts as those in the first embodiment, and detailed descriptions will be omitted as appropriate.

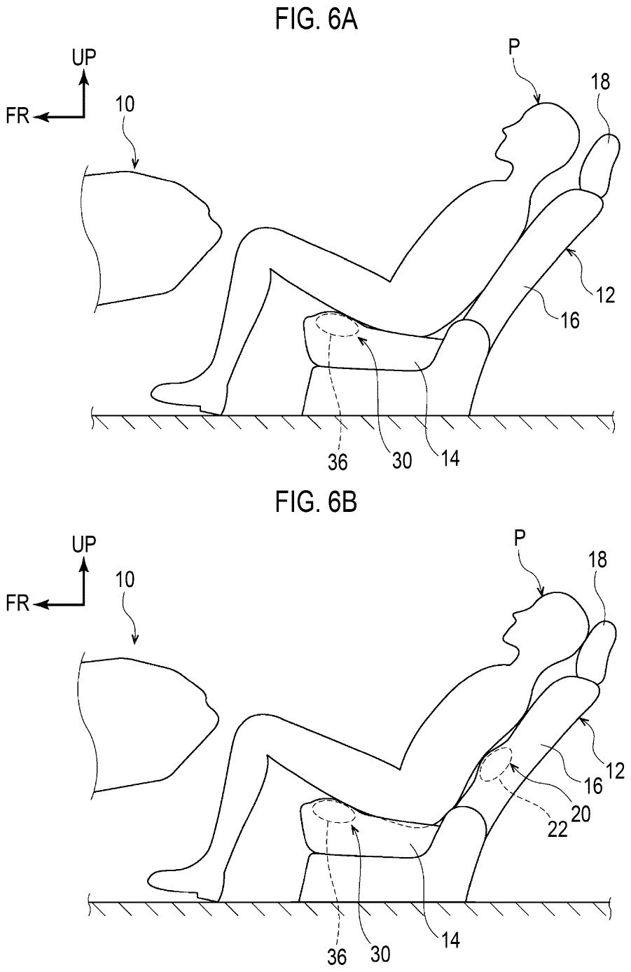

As shown in FIGS. 6A and 6B, the third embodiment differs from the first embodiment merely in that the lifting mechanism 30 is configured with a seat cushion airbag 36 and an inflator (not shown) that injects gas into the seat cushion airbag 36.

The seat cushion airbag 36 is built in a front portion of the seat cushion 14, and an inflator that injects gas into the seat cushion airbag 36 is provided inside or outside the seat cushion 14. The inflator that injects gas into the seat cushion airbag 36 is electrically connected to the control device 28.

Therefore, when the reclining angle of the seat back 16 is equal to or greater than the predetermined angle θ and the frontal collision of the vehicle 10 is predicted, the control device 28 first operates the inflator that injects gas into the seat cushion airbag 36, thereby inflating the seat cushion airbag 36. Thereafter, the control device 28 operates the inflator that injects gas into the lumbar support airbag 22, thereby inflating the lumbar support airbag 22.

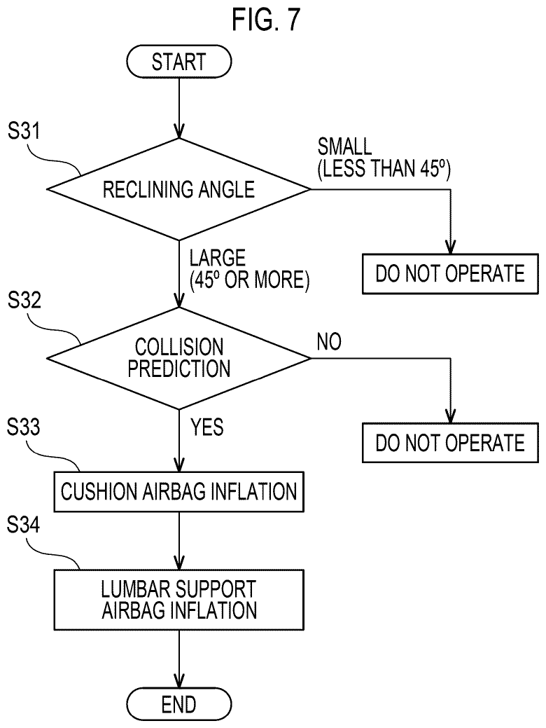

In the vehicle seat 12 according to the third embodiment configured as described above, the operation (control method) will be described below with reference to a flowchart shown in FIG. 7. The same operations as those of the first embodiment will be omitted as appropriate.

As shown in FIG. 7, first, the reclining angle of the seat back 16 is detected by the detection sensor 24 (S31). When the reclining angle is less than a predetermined angle θ (for example, θ=45 degrees), the lifting mechanism 30 and the pressing mechanism 20 do not operate. When the reclining angle is equal to or greater than a predetermined angle θ, it is then determined whether a frontal collision prediction of the vehicle 10 is predicted (S32). In a case where a frontal collision of the vehicle 10 is not predicted, the lifting mechanism 30 and the pressing mechanism 20 do not operate.

In a case where the frontal collision of the vehicle 10 is predicted, first, as shown in FIG. 6A, the control device 28 operates the inflator that injects gas into the seat cushion airbag 36 as the lifting mechanism 30, thereby inflating the seat cushion airbag 36. As a result, the front portion of the seat cushion 14 is lifted (lifting step: S33).

Thereafter, as shown in FIG. 6B, the control device 28 operates the pressing mechanism 20. That is, the control device 28 operates the inflator that injects gas into the lumbar support airbag 22, thereby inflating the lumbar support airbag 22 (pressing step: S34).

As described above, in the third embodiment, as in the first embodiment, when the reclining angle of the seat back 16 is equal to or greater than the predetermined angle θ and the frontal collision of the vehicle 10 is predicted, the pressing mechanism 20 is operated after the lifting mechanism 30 is operated. That is, after the front portion of the seat surface 14A of the seat cushion 14 is lifted, a portion of the front surface 16A of the seat back 16 is pressed toward the front side.

Therefore, the movement of the occupant P toward the front side is effectively suppressed, and even when the vehicle 10 experiences a frontal collision while traveling with the seat back 16 reclined by a predetermined angle θ or more, the occurrence of the submarining phenomenon in the occupant P can be effectively suppressed. In addition, since the lifting mechanism 30 is the seat cushion airbag 36, the front portion of the seat surface 14A of the seat cushion 14 can be effectively lifted.

Above, the vehicle seat 12 and the control method thereof according to the present embodiment have been described based on the drawings. The vehicle seat 12 and the control method thereof according to the present embodiment are not limited to the shown examples, and various design modifications can be made as appropriate without departing from the gist of the present disclosure. For example, the pressing mechanism 20 and the lifting mechanism 30 are not limited to those of the above-described embodiments. The vehicle seat 12 according to the present embodiment may be provided as a rear seat of the vehicle 10, or may be provided as a front seat or a rear seat of a vehicle that does not have an autonomous driving mode.

What is claimed is:

1. A vehicle seat comprising:
a seat cushion on which an occupant is seated;
a seat back configured to be reclinable and to support a back of the occupant;
a lifting mechanism provided in the seat cushion and configured to lift a front portion of a seat surface of the seat cushion; and
a pressing mechanism provided in the seat back and configured to press part of a front surface of the seat back toward a front side of the vehicle seat, wherein, when a reclining angle of the seat back is equal to or greater than a predetermined angle and a frontal collision of a vehicle is predicted, the pressing mechanism is operated after the lifting mechanism is operated.

2. The vehicle seat according to claim 1, wherein:
the lifting mechanism is an electric tilt mechanism, a cushion restraint device, or a seat cushion airbag; and
the pressing mechanism is a lumbar support airbag or an electric lumbar support.

3. A vehicle seat control method of controlling the vehicle seat according to claim 1, the vehicle seat control method comprising:
operating the lifting mechanism to lift the front portion of the seat surface of the seat cushion when the reclining angle of the seat back is equal to or greater than the predetermined angle and the frontal collision of the vehicle is predicted; and
after the front portion of the seat surface of the seat cushion is lifted, operating the pressing mechanism to press the part of the front surface of the seat back toward the front side of the vehicle seat.
